(19) United States
(12) Patent Application Publication
(10) Pub. No.: US 2022/0234489 A1
(43) Pub. Date: Jul. 28, 2022

(54) ELECTRIC VEHICLE FLEET OF DELIVERY VEHICLES

(71) Applicant: Acton, Inc., Livermore, CA (US)

(72) Inventors: Andrew Tam, Livermore, CA (US); Peter Treadway, Livermore, CA (US)

(21) Appl. No.: 17/721,344

(22) Filed: Apr. 14, 2022

Related U.S. Application Data
(63) Continuation-in-part of application No. 16/843,918, filed on Apr. 9, 2020, now Pat. No. 11,322,030.
Application No. 16/843,918 is a continuation-in-part of application No. 16/569,151, filed on Sep. 12, 2019.
(60) Provisional application No. 62/864,927, filed on Jun. 21, 2019.

(51) Int. Cl. B60P 1/64; H04L 9/30; B60P 3/00; G08G 1/00

(52) U.S. Cl. CPC B60P 1/6409; G08G 1/202; B60P 3/007; H04L 9/30

(57) ABSTRACT

An electric vehicle is in a fleet. A first electric vehicle includes one or more components that have unique identifications and a unique public key stored at the one or more components. When a message is received by the first electric vehicle, the first and second components provide a verification of their existence. The first and second components decrypt and verify their parts of the message. A first electric vehicle processor is provided. The first electric vehicle processor provides at least one of a database, an order module, a distribution module, and a loading module.

### CROSS REFERENCE TO RELATED APPLICATIONS

This application is a Continuation-In-Part of U.S. patent application Ser. No. 16/843,918, filed on Apr. 9, 2020, which is a Continuation-In-Part of U.S. patent application Ser. No. 16/569,151, filed Sep. 4, 2019, which claims the benefit of U.S. Provisional Patent Application No. 62/864,927, filed Jun. 21, 2019, all of which are incorporated by reference herein in their entirety for all purposes.

### BACKGROUND

### Field of the Invention

The present invention relates to electrical vehicles, and more particularly to an electrical vehicle fleet of delivery vehicles.

### Brief Description of the Related Art

Autonomous delivery vehicle has been used that include a location sensor configured to detect the location of the delivery vehicle; a target sensor on the vehicle configured to detect a target associated with a receptacle and to receive a signal in response to detecting the target; a processor configured to determine the location of the receptacle based on the received signal; and automatically move the vehicle to the determined location.

One limitation is that the location sensor is configured to determine when the autonomous delivery vehicle is within a geofence.

Another limitation is that the target sensor is configured to detect a target associated with a receptacle when the vehicle is determined to be within the geofence corresponding to the receptacle. A further limitation is that the location sensor is

configured to detect geospatial coordinates of the vehicle.

There is a need for an improved autonomous delivery vehicle and system.

### SUMMARY

An object of the present invention is to provide an autonomous and/or semi-autonomous vehicle for the delivery of items such as food and beverages.

Another object of the present invention is to provide an autonomous or semi-autonomous vehicle with a distribution module assigning one or more item profiles associated with orders, based on the assignment of each of the one or more item profiles.

A further object of the present invention is to provide an autonomous or semi-autonomous electric vehicle for the delivery of items.

These and other objects are achieved in an electric vehicle in a fleet. A first electric vehicle includes one or more components that have unique identifications and a unique public key stored at the one or more components. When a message is received by the first electric vehicle, the first and second components provide a verification of their existence. The first and second components decrypt and verify their parts of the message. A first electric vehicle processor is provided. The first electric vehicle processor provides at least one of a database, an order module, a distribution module, and a loading module.

### BRIEF DESCRIPTION OF THE DRAWINGS

FIG. 1 is a perspective view of an exemplary autonomous vehicle comprising a plurality of compartments, in accordance with some embodiments;

FIG. 2 illustrates one embodiment of electric vehicle with public and private keys, and vehicle to vehicle communication.

FIG. 3 illustrates one embodiment of the present invention.

FIG. 4 is a flowchart of an exemplary fleet control system, in accordance with some embodiments;

FIG. 5 is a flowchart of an exemplary fleet control module, in accordance with some embodiments;

FIG. 6 is a non-limiting schematic diagram of a digital processing device; in this case, a device with one or more CPUs, a memory, a communication interface, and a display, in accordance with some embodiments;

FIG. 7 is a non-limiting schematic diagram of a web/mobile application provision system; in this case, a system providing browser-based and/or native mobile user interfaces, in accordance with some embodiments;

FIG. 8 is a non-limiting schematic diagram of a cloud-based web/mobile application provision system; in this case, a system comprising an elastically load balanced, auto-scaling web server and application server resources as well synchronously replicated databases, in accordance with some embodiments;

FIG. 9 is a non-limiting schematic diagram of a platform for autonomously or semi-autonomously delivering a food or beverage item to a plurality of customers;

FIG. 10 is a non-limiting schematic diagram of a platform for autonomously or semi-autonomously delivering a food or beverage item to a plurality of customers; and

FIG. 11 is a non-limiting perspective illustration of storage units within a vehicle.

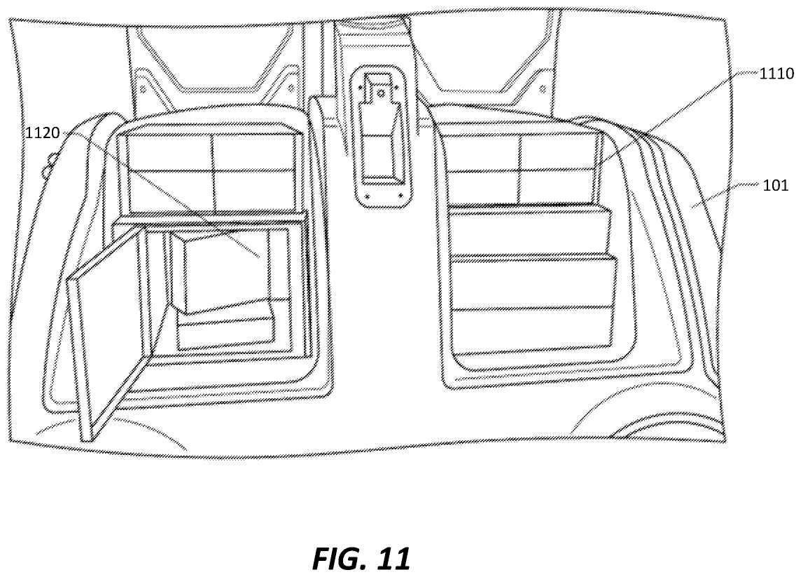

### DETAILED DESCRIPTION

### Terms and Definitions

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As used herein, the terms “fleet,” “sub-fleet,” and like terms are used to indicate a number of land vehicles, operating together or under the same ownership. In one embodiment the fleet or sub-fleet is engaged in the same activity. In one embodiment, the fleet or sub-fleet are engaged in similar activities. In one embodiment, the fleet, or sub-fleet are engaged in different activities.

As used herein, the terms “autonomous vehicle,” “vehicle fleet,” “vehicle,” “all-terrain vehicle,” and like terms are used to indicate a mobile machine that transports cargo. Typical vehicles include cars, wagons, vans, unmanned motor vehicles (e.g., tricycles, trucks, trailers, buses, etc.), unmanned railed vehicles (e.g., trains, trams, etc.), unmanned

As used herein, the terms “user,” “operator,” “fleet operator,” and like terms are used to indicate the entity that owns or is responsible for managing and operating the vehicle fleet.

As used herein, the term “customer” and like terms are used to indicate the entity that requests the services provided the vehicle fleet.

As used herein, the terms “provider,” “business,” “vendor,” “third party vendor,” and like terms are used to indicate an entity that works in concert with the fleet owner or operator to utilize the services of the vehicle fleet to deliver the provider's product from and or return the provider's product to the provider's place of business or staging location.

As used herein, the terms “server,” “computer server,” “central server,” “main server,” and like terms are used to indicate a computer or device on a network that manages the fleet resources, namely the autonomous vehicles.

As used herein, the term “controller” and like terms are used to indicate a device that controls the transfer of data from a computer to a peripheral device and vice versa. For example, disk drives, display screens, keyboards, and printers all require controllers. In personal computers, the controllers are often single chips. As used herein the controller is commonly used for managing access to components of the autonomous vehicle such as the securable compartments.

As used herein a “mesh network” is a network topology in which each node relays data for the network. All mesh nodes cooperate in the distribution of data in the network. It may be applied to both wired and wireless networks. Wireless mesh networks may be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs may take any form of network topology. Mesh networks may relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept may also apply to wired networks and to software interaction. A mesh network whose nodes are all connected to each other is a fully connected network.

As used herein, the term “module” and like terms are used to indicate a self-contained hardware component of the central server, which in turn comprises software modules. In software, a module is a part of a program. Programs are composed of one or more independently developed modules that are not combined until the program is linked. A single module may contain one or several routines, or sections of programs that perform a particular task. As used herein the fleet management module comprises software modules for managing various aspects and functions of the vehicle fleet.

As used herein, the terms “processor,” “digital processing device,” and like terms are used to indicate a microprocessor or central processing unit (CPU). The CPU is the electronic circuitry within a computer that carries out the instructions of a computer program by performing the basic arithmetic, logical, control and input/output (I/O) operations specified by the instructions.

### Delivery Vehicle Description

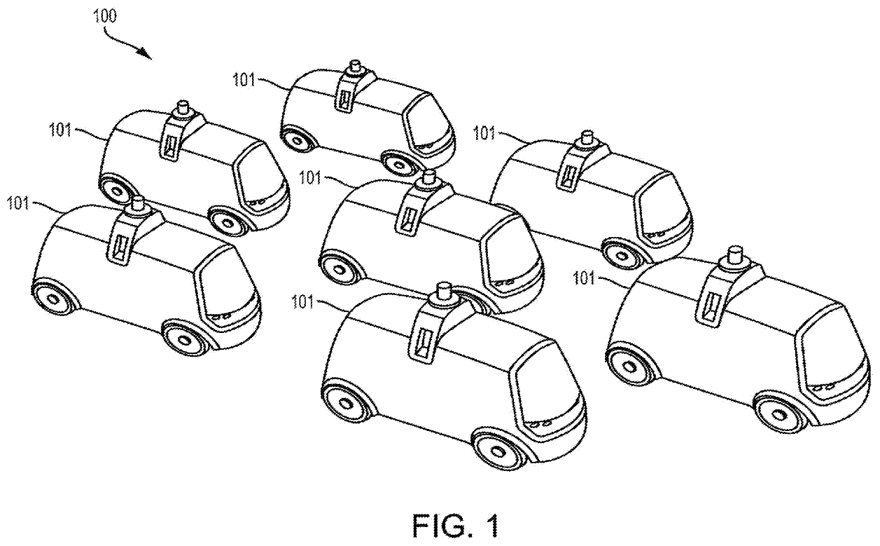

Referring to FIG. 1, a vehicle fleet 100, includes a plurality of autonomous or semi-autonomous vehicles 101.

In one embodiment, one or more of the vehicles 101 in a vehicle fleet 100 are autonomous. In one embodiment, one or more of the vehicles 101 in the vehicle fleet 100 are autonomous. In one embodiment the semi-autonomous vehicles 101 can be manually controller by an operator. Manual override may be required to, for example, address navigation malfunctions, provider inventory issues, or unanticipated traffic, mechanical failure, electrical failure, traffic accident, and road conditions. In one embodiment of the plurality of autonomous vehicles 101 within the fleet 100 is operated on behalf of third-party vendor or service provider. The third-party vendor or service provider includes a food and beverage provider.

In one embodiment, one or more of the vehicles 101 within the vehicle fleet 100 are configured to be part of a sub-fleet 100 a that operates independently or in tandem with other sub-fleets 100 a. In one example, the sub-fleet 100 vehicles 101 may only provide a product, service, or level of service associated with a single vendor. Each of the vehicles 101 in the sub-fleet 100 a may display a logo of the vendor or an alternative indicator representing the specific product, service, or level of service associated with that vehicle 101. Levels of service may include immediate dedicated rush service, guaranteed morning/afternoon delivery service, and general delivery service. Some sub-fleets 100 a may offer a faster or more prioritized service than other sub-fleets 100.

### Autonomous and Semi-Autonomous Vehicles

In one embodiment, each vehicle 101 includes any number of wheels, including but not limited to 4. In one embodiment, each electric vehicle includes batteries. The batteries may be attached to an underside of the vehicle 101.

In one embodiment, the battery may be electrically coupled to a motor of the electrical cables and an electrical connector. The electrical connector may be a quick twist connector that is opened and closed by twisting its halves in opposite directions.

In one embodiment, instead of using electrical cables, the vehicle may include electrical connectors that mate when the deck assembly is installed in the vehicle 101. The electrical connectors may be surrounded by cushions that protect the connectors from micro vibrations, dirt and water, and the like.

Each vehicle 101 in the fleet 100 includes a sensor system comprising a plurality of onboard sensors such as, for example, a camera, a video camera, a LiDAR, a radar, an ultrasonic sensor, and a microphone. Each vehicle 101 may further comprise an internal computer for real time navigation and obstacle avoidance, based on the data received by the sensors.

In one embodiment, the vehicles may further comprise an autonomous propulsion system sensor configured to monitor drive mechanism performance (e.g., the propulsion engine), power system levels (e.g., battery, solar, gasoline, propane, etc.), monitor drive train performance (e.g., transmission, tires, brakes, rotors, etc.), or any combination thereof.

In one embodiment each vehicle can include a battery case 106 mounted underneath a deck 112. The battery case 106 includes one or more batteries (not shown). The batteries are electrically coupled to an electric drive motor 108, which is protected by a housing 110. The vehicle 100 may be steered by turning a handlebar 116. The speed of the motor 108 may be controlled using a throttle 114 mounted on a steering mechanism 116.

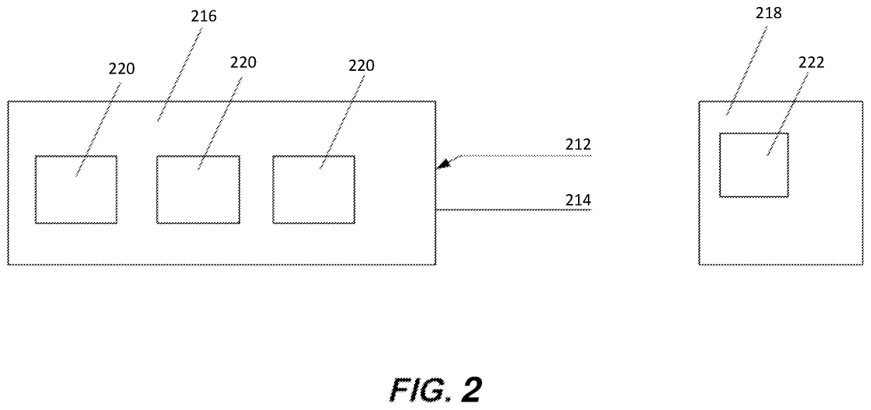

In one embodiment, illustrated in FIG. 2, electric vehicles 1516 are provided with systems and methods for vehicle security without a hardware secure element 210. Hardware secure elements 210 usually allow for the storage of private keys 212, which are used to sign and encrypt data. In one embodiment the present invention removes the dependency on a hardware secure element 210 as part of the whole security system.

Private keys and private key pairs (collectively 212 and 214) are used to cryptographically secure sensitive information. private keys 212 can be used to decrypt, encrypt, or sign data. the corresponding public key 214 can be used to decrypt or verify the signature of the data signed by its private key. public keys cannot be used to encrypt or sign data.

As a non-limited example, as used herein a vehicle 216 is a means of carrying or transporting something including but not limited to an EV motor vehicle 216, including but not limited to a vehicle, skateboard, skates, and the like.

As used herein an encryption key is a piece of information that determines the functional output of a cryptographic algorithm. For encryption algorithms, a key specifies the transformation of plaintext into ciphertext, and vice versa for decryption algorithms. Keys also specify transformations in other cryptographic algorithms, such as digital signature schemes and message authentication codes.

As used herein, the cloud 218 is a global network of servers, each with a unique function. The is not a physical entity, but instead is a vast network of remote servers around the globe which are hooked together and meant to operate as a single ecosystem. These servers are designed to either store and manage data, run applications, or deliver content or a service such as streaming videos, web mail, office productivity software, or social media. Instead of accessing files and data from a local or personal computer, you are accessing them online from any internet-capable device—the information will be available anywhere you go and anytime you need it. In the case of this embodiment the cloud 218 is securely storing and generating public key and private key pairs for each component in the vehicle 216.

As non-limiting examples, there are four different methods to deploy 8 resources.

These include: a public cloud 218 that shares resources and offers services to the public over the Internet; a private cloud that isn't shared and offers services over a private internal network typically hosted on-premises; a hybrid cloud that shares services between public and private clouds depending on their purpose; and a community cloud 218 that shares resources only between organizations, such as with government institutions.

In one embodiment, system 10 is coupled to the cloud 218.

As used herein, a local area network (LAN) is a network that interconnects within a limited area such as a residence, school, laboratory, university campus or office building. By contrast, a wide area network (WAN) not only covers a larger geographic distance, but also generally involves leased telecommunication circuits. Ethernet and Wi-Fi are two common technologies in use for local area networks. Historical network technologies include ARCNET, Token ring, and AppleTalk.

As a non-limiting example, a wide area network (WAN) is a network that exists over a large-scale geographical area. A WAN connects different smaller networks, including local area networks (LANs) and metro area networks (MANs). This ensures that computers and users in one location can communicate with computers and users in other locations. WAN implementation can be done either with the help of the public transmission system or a private network.

As a non-limiting example, system 10 is coupled to the cloud. This can be achieved via GSM, WiFi, satellite, a mobile device and the like.

Other wireless standards that are specifically designed for IoT devices are becoming available such as LoRA, NB-IOT and LTE-M, and the like.

As a non-limiting example, in one embodiment one or more hardware elements 210 of the vehicle 216 has public keys 214 stored therein. Secure encryption is not put on the hardware elements 210.

A vehicle 216 consists of one or more in individual components 220. Individual components 220 of the vehicle 216 are given an Acton Unique Identifier (AUIDs). When a vehicle 216 is activated the first time, a unique public key 214 and private key 212 pair are generated by the cloud. AUIDs, public key and private keys 214 and 212 are then stored in the cloud. Each component stores its AUID and public key in persistent memory within the component thus eliminating theft of private keys 212.

For selected components 220 of the vehicle 216, the cloud 218 produces a unique private key 212 and a public key 214. As a non-limiting example, with the present invention, private keys 2112 are secure and in the cloud. They cannot be taken from the vehicle 216. Non-limiting examples of vehicle 216 components 220 with public keys 214 include but are not limited to: IOTA, the battery, motor controller, and the like.

As non-limiting examples, a simple electric vehicle 216 can include a battery; vehicle control unit (motor controller), and IoT gateway. Each of these components 220 is given an AUID. Additional components 220 include but are not limited to vehicle locks; dashboards; helmets; docking stations; and the like.

As non-limiting examples, selected vehicle components 220 have unique IDs with a unique identifier. These components 220 are given a unique key pair. As a non-limiting example, the private key 212 is securely stored in the cloud. An associated public key 212 is stored in the vehicle components 220. Communication in the cloud 218 can be authenticated with the vehicle 216 through the components 220 that have public keys.

As a non-limiting example of authentication steps, public keys 214 are passed to the vehicle 216, e.g., vehicle components 220. The private key 212 is stored in the cloud, and the public key 214 is transferred to a respective vehicle component.

As a non-limiting example, when the vehicle 216 connects to the server 222, it tells the server 222 it has components 220 A, B, and C. The System looks up in an associated database and generates an activation message composed of multiple parts, each part signed with the private key 212 that corresponds to the AUID of the vehicle component A, B, or C 210. When the activation message is received by the vehicle 216, the individual components 220 A, B, and C will decrypt and verify their parts of the message. If anyone component's message part fails verification, the vehicle 216 will not activate.

As a non-limiting example, a secret key is not needed that unlocks the entire scoter. Instead, the system creates components 220 are identified as being unique with associated keys.

In one embodiment fleets of vehicles are used to distribute information between vehicles in the fleet. As a non-limiting example, individual fleet vehicles have two wireless communication networks. The first is any kind of cloud 218 connectively. The second one is any kind of local wireless communication.

When vehicles communicate with the cloud, they report their status occasionally. When they report status, they report the presence of other fleet-vehicles that they have detected on local wireless. As a non-limiting example, this status message can then be communicated with other fleet vehicles IDs that are within local communication. This provides information about the location of fleet vehicles, which can be used to reduce theft and increase fleet availability.

As a non-limiting example, data can be distributed to the fleet by seeding it to only certain vehicles, and these vehicles that receive the communications then communicate with other vehicles. Data that could be sent includes, but is not limited to updates, navigation information, vehicle configuration, secure one-time-keys. This mechanism decreases fleet-wide data-usage and improves fleet operation.

As a non-limiting example, a vehicle 216 can detect, via local wireless communication, other vehicles, report their presence to the cloud, and the can then determine if another vehicle 216 is located within a selected proximity. The cloud 218 can then determine if the reporting vehicle 216 can communicate data to the other vehicle. The cloud 218 can then send a one-time use session key to the vehicles, allowing them to communicate securely.

When a vehicle 216 communicates with the cloud 218 that it sees another vehicle, it sends this message up to the cloud. The cloud 218 can use this vehicle 216 presence information to disable vehicles, track stolen vehicles, locate missing vehicles, and the like.

Fleet vehicles are vehicles operated by an entity that provides them for public or private use to individuals or employees. A fleet is a group of one or more Fleet Vehicles that an operator makes available for use. Private vehicles are vehicles operated by individuals for their own use.

In one embodiment, this invention can be used with both fleet and individual vehicles. If individual or fleet Operators of EV include their vehicle 216 in this system, the benefits of lost vehicle 216 discovery, reduced data usage, and the like can be extended across fleets and individuals. In this way, the fleet vehicles of Operator A can look for a stolen fleet vehicle 216 of Operator B, while a private vehicle 216 operated by individual C can receive software update data from Operator A's fleet.

When misplaced or stolen fleet or individual vehicles are located, the owner and/or authorities can be notified.

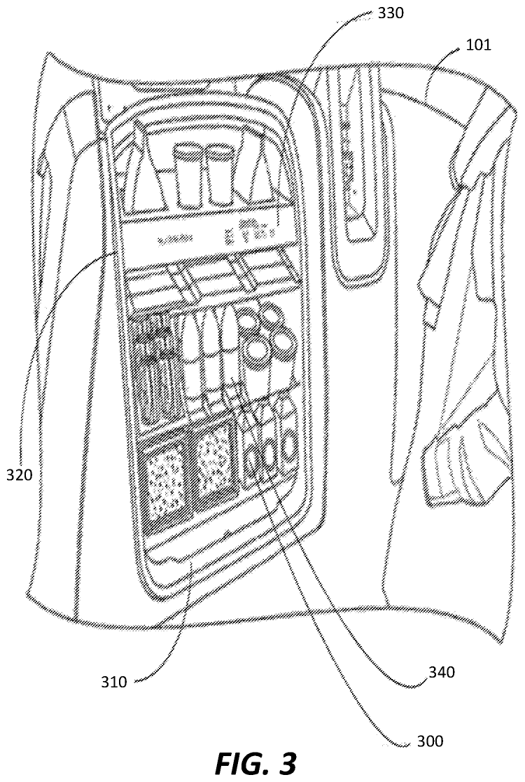

In one embodiment illustrated in FIG. 3, each of a vehicle 101 can include one or more display cases 130 comprises the item 300, a display fastener 320 and at least one of: a temperature control system configured to maintain a target temperature within the removable display case 310; a display screen 330 configured to display a case media; and a vending device 340 configured to vend the item 300. In one embodiment, the autonomous vehicle 101 further comprises a vehicle interior fastener configured to removably affix the display fastener 320. The autonomous vehicle 101 may further comprise an energy storage device configured to provide energy to the removable display case 310. In one embodiment, the energy storage device is further configured to provide power to the autonomous propulsion system, the display, the vending device, or any combination thereof.

In one embodiment, the application comprises a transmission module configured to receive an instruction from a fleet management module; the instruction comprising a route, and at least one of the target temperatures and the case media; and a command module configured to communicate at least one of the target temperatures and the case media to the removable display case 310, and a navigation module configured to direct the autonomous propulsion system based on the route. In one embodiment, the command module is configured to communicate the target temperature, the media, or both to the removable case through a communication hub. In one embodiment, the communication hub comprises a Wi-Fi router, a Bluetooth router, a cellular network, a jack, an outlet, a wire, or any combination thereof. In one embodiment, the route comprises a location of the customer.

In one embodiment, the display fastener 320 comprises a hook, a ring, a shelf, a bar, a spring, a bolt, a nut, a bearing, a bushing, a tie, a clip, a chain, a rack, or any combination thereof. In one embodiment, the vehicle interior fastener comprises a hook, a ring, a shelf, a bar, a spring, a bolt, a nut, a bearing, a bushing, a tie, a clip, a chain, a rack, or any combination thereof.

In one embodiment, the case media is based on the item 300, the target temperature, the route, or any combination thereof. In one embodiment, the autonomous vehicle 101 further comprises a screen configured to display a vehicular media. In one embodiment, the vehicular media comprises the item, the target temperature, the media, the route, or any combination thereof.

In one embodiment, the autonomous vehicle 101 further comprises a lock configured to prevent unauthorized removal of the display case from the autonomous vehicle. In one embodiment, at least one of the vehicles interior fasteners and the display fastener comprise the lock. In one embodiment, the autonomous vehicle 101 further comprises a strain relief configured to prevent damage to the autonomous vehicle, the display case, the energy storage device the autonomous propulsion system, or any combination thereof.

In one embodiment, the autonomous vehicle 101 further comprises at least one of a power outlet, a data port, and an exhaust port. The power outlet may be configured to provide one or more power ratings to removable display case 310 to power the display screen and/or any additional electrical components within the removable display case 310. The data port may enable data transmission to and/or from the removable display case 310 and transmission module and the command module. The data includes a stock of items within the removable display case 310, a current temperature removable display case 310, the case media, a price associated with the item 300, or any combination thereof.

At least one of the autonomous vehicles and the compartment includes a controller configured to associate each one of the pluralities of securable compartments 102, 104 to an assigned customer or provider and provide entry to the securable compartments 102, 104 upon authorization. Each securable compartment 102, 104 may be secured separately to transport goods to separate sets of customers. As such, the autonomous vehicle may deliver a first good or service to a first assigned customer from within a first securable compartment 102 and then deliver a second good or service to a second assigned customer from within the second securable compartment 104.

Upon arrival of the autonomous vehicle to the customer destination, the customer may open their respective compartment(s) by verifying their identity. In one embodiment, the customer verifies their identity by providing a PIN (e.g., 4-digit number) via a touchscreen or a keypad within the autonomous vehicle, which they received upon initial request/order. The customer may verify themselves using their mobile phone and an RFID reader on the autonomous vehicle. Alternatively, the customer is verified through voice recognition of a keyword or key-phrase, wherein the autonomous vehicle comprises a microphone and a voice recognition application for recognition thereof. Further, in another embodiment, the customer is verified through facial or identification recognition, wherein the autonomous vehicle comprises a camera and a facial recognition application for recognition thereof. Additionally, or alternatively, the customer is verified through a magnetic strip, RFID key or any other computer readable form of identification. Finally, in another embodiment, the customer is verified by entering a code or identification value on their mobile device, wherein the autonomous vehicle receives a cellular signal comprising a confirmation of the user or data related to the code of identification of the user.

### Fleet Management Module

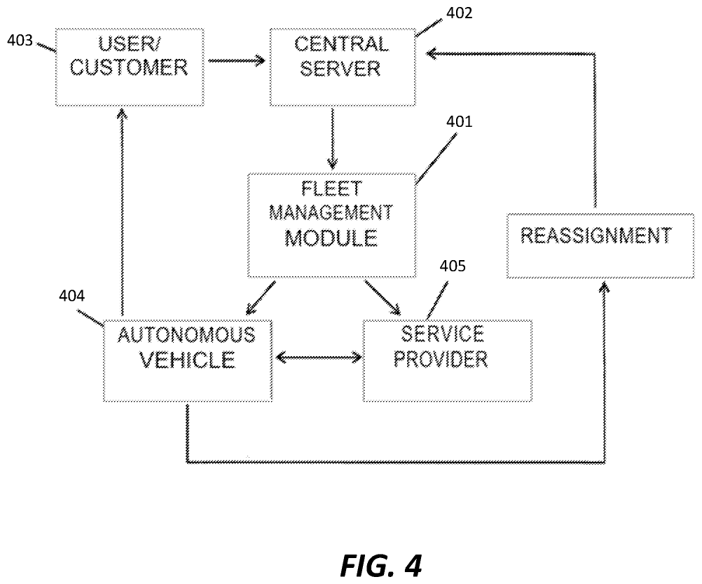

Provided herein, per FIG. 4, is a system for fleet management comprising a fleet management module 401, a central server 402, a vehicle 404, a customer 403, and a service provider 405. In one embodiment, the fleet management module 401 coordinates, assigns tasks, and monitors the position of each of the plurality of vehicles 404 in the fleet. The fleet management module 401 may coordinate the vehicles 404 in the fleet to monitor and collect data regarding unstructured open or closed environments, and report to the service provider 405. As seen, the fleet management module 401 may coordinate with a central server 402. The central server 402 may be located in a central operating facility owned or managed by the fleet owner. The service provider 405 includes a third-party provider of a good or service. The service provider 405 includes a vendor, a business, a restaurant, a delivery service, a retailer, or any combination thereof.

In one embodiment, the fleet management module 401 is configured to receive, store and transmit data to and/or from the service provider 405. The fleet management module 401 may receive and transmit data to and/or from the service provider 405 via a service provider application. In one embodiment, the service provider application comprises a computer application, an internet application, a tablet application, a phone application, or any combination thereof.

In one embodiment, the central server 402 is configured to receive, store and transmit data to and/or from the customer 403. The central server 402 may receive and transmit data to and/or from the customer 403 via a customer application. In one embodiment, the customer application comprises a computer application, an internet application, a tablet application, a phone application, or any combination thereof.

In one embodiment, the vehicle 404 comprises a memory device to store the data for future data transfer or manual download.

In one example, an order by a customer 403 is transmitted to a central server 402, which then communicates with the fleet management module 401, which relays the order to the service provider 405 associated with the order and a vehicle 404. The fleet management module 401 may employ one or more vehicles 404 or sub-fleet vehicles 404 that are closest to the service provider 405, customer 403, or both. The assigned service provider then interacts with that vehicle 404 through a service provider application to supply the vehicle 404 with any goods, maps, or instructions associated with the order. The vehicle 404 then travels to the customer 403 and reports completion of the order to at least one of the customers 403, the service provider 405, the central server 402, and the fleet management module 401.

In one embodiment the vehicle 404 may be operated on behalf of the service provider 405, wherein at least one of the central servers 402 and the fleet management module 401 is operated by the service provider 405. In any one of the embodiments, the vehicle 404 is controlled directly by the customer 403, the service provider 405, or both. In one embodiment, human interaction of the vehicle 404 may be required to address maintenance issues such as mechanical failure, electrical failure or a traffic accident.

In one example, the fleet management module 401 receives an instruction from the service provider 405 to collect an item at a first location and deliver the item to a second location. Upon receipt of the instruction, the fleet management module 401 may assign one or more of the vehicles 404 to perform the instruction by navigating the one or more of the vehicles 404 the first location. The one more of the vehicles 404 may then confirm the receipt of the item and navigate to the second location. The one more of the vehicles 404 may then deliver the item to the second location and confirm receipt of the delivery. In one embodiment, the one more of the vehicles 404 may further receive an identification associated with the first location, the second location, or both, to enable receipt and delivery of the item.

In one example, a request by the customer 403 is sent to the central server 402, which then communicates with the fleet management module 401 to relay the request to the service provider 405, which instructs the vehicles 404. The fleet management module 401 may select one or more of the vehicles 404 within the geographic region and/or proximity of the customer 403, the service provider 405, or both. The vehicles 404 may be first directed to a location associated with the service provider 405 to receive an item associated with the request. The vehicle 404 may then travel to a location associated with the customer 403. The customer 403 may then interacts with the one or more vehicle 404 to retrieve the item. The customer 403 may retrieve the item by opening a compartment within the vehicle 404. The customer 403 may open the compartment within the vehicle 404 through a customer application, or a customer interface comprising, for example, an RFID reader, a touchpad, a keypad, a voice command, or a vision-based recognition. Upon completion the vehicles 404 may then report a completion of the request to the fleet management module 401 and be reassigned to a subsequent request.

In one embodiment, the autonomous fleet may be strategically positioned throughout a geographic region in anticipation of a known demand. Demand for autonomous vehicle services may be predicted by storing historical demand data relating to the quantity, timing, and type of request received in each region. Such demand predictions may further be weighted by the cost or importance of the good or service and employ historical trends for higher efficiency and throughput. As such, the fleet management module may position the autonomous vehicles as close as possible to the expected source locations.

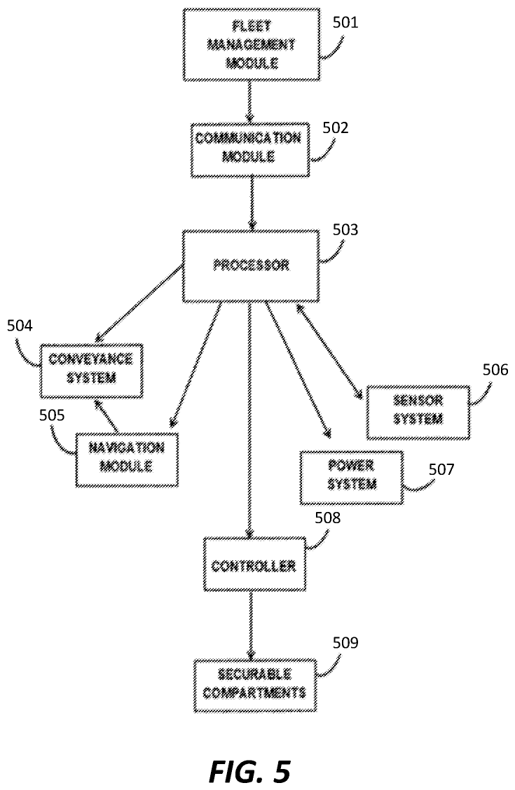

As illustrated in FIG. 5, the fleet management module 501 instructs the processor 503 of the autonomous or semi-autonomous vehicle via a communication module 502. The processor 503 may be configured to send an instruction and receive a sensed data from the sensor system 506, and may further control at least one of the power systems 507, the navigation module 505, and the conveyance system 504. The processor 503 may additionally be configured to instruct a controller 508 to open a securable compartment 509 to release any contents associated with an order. The processor 503 may allow manual override of the conveyance system 504, the navigational system 505, or both.

In one embodiment, the processor 503 is in functional communication with the communication module 502. In one embodiment, the communication module 502 is adapted to receive, store, and/or transmit data to and from the customer and the fleet management module 501. In one embodiment, the data comprises a schedule, a request or order, a current location, a delivery location, a service provider location, a route, an estimated time of arrival (ETA), a repositioning instruction, a vehicle condition, a vehicle speed, or any combination thereof. In one embodiment, the processor 503 is capable of both high-level computing for processing as well as low-level safety-critical computing capacity for controlling the hardware. The processor 503 may configured to direct the conveyance system 504, the navigation module 505, the sensor system 506, the power system 507, the controller 508, or any combination thereof. The processor 503 may reside aboard the autonomous or semi-autonomous vehicle, or at a remote location.

In one embodiment, the communication module 502 is configured to receive, store and transmit data via wireless transmission (e.g., 4G, 5G, or satellite communications). In one embodiment, the wireless transmission occurs via: a central server, a fleet management module, a mesh network, or any combination thereof. In one embodiment, the customer application is configured to send and receive data via an electronic device comprising a phone, a personal mobile device, a personal digital assistant (PDA), a mainframe computer, a desktop computer, a laptop computer, a tablet computer, and/or wearable computing device comprising: a communication headset, smart glasses, or a combination thereof.

In one embodiment, the fleet management module 501 directs each of the vehicles 404 through a navigation module 505. In one embodiment, the navigation module 505 controls the conveyance system 504 to translate the autonomous or semi-autonomous vehicle through the unstructured open or closed environments. In one embodiment, the navigation module 505 comprises an HD map, a weather condition, an elevation map, a digital map, a street view photograph, a GPS point, or any combination thereof. In one embodiment, the map is generated by a customer, a customer, a service provider, a fleet operator, an online repository, a public database, or any combination thereof. In one embodiment, the map is generated only for intended operational geography. The maps may be augmented or confirmed by data obtained by the sensor system 506. The navigation module 505 may further implement data collected by the sensor system 506 to determine the location and/or the surroundings of the autonomous or semi-autonomous vehicle. In one embodiment, the map further comprises a navigation marker comprising a lane, a road sign, an intersection, a grade, or any combination thereof. As such the navigation module 505, in combination with processors and/or applications vehicles 404 enable a safe, robust navigation trajectory.

In one embodiment, the fleet management module 501 is configured to determine and predict a geographic demand for the autonomous or semi-autonomous vehicles for strategic placement throughout a geographic region in anticipation of a known demand. The fleet management module 501 may determine and predict a geographic demand by storing data relating the location, quantity, time, price, item, item type, service, service type, service provider, or any combination thereof of placed orders and requests. Further, the service provider may provide independently measured trends to supplement or augment the measured trends. As such, the vehicles may be strategically placed to reduce transit and idle time and to increase sales volume and efficiency.

### Operating Environments

The autonomous vehicles in the fleet may be configured to operate within a variety of unstructured open operating environments to enable service to a broad range of locations. In one embodiment, the unstructured open environment is a non-confined geographic region accessible by navigable pathways comprising: public roads; private roads; bike paths; open fields, open public lands, open private lands, pedestrian walkways, lakes, rivers, or streams. In one embodiment, the closed environment is a confined, enclosed, or semi-enclosed structure accessible by navigable pathways comprising: open areas or rooms within commercial architecture, with or without structures or obstacles therein; airspace within open areas or rooms within commercial architecture, with or without structures or obstacles therein; public or dedicated aisles; hallways; tunnels; ramps; elevators; conveyors; or pedestrian walkways. In one embodiment, the unstructured open environment is a non-confined airspace or even near-space environment which includes all main layers of the Earth's atmosphere comprising the troposphere, the stratosphere, the mesosphere, the thermosphere and the exosphere. In one embodiment, the navigation module controls routing of the conveyance system of the vehicles in the fleet in the unstructured open or closed environments.

### Goods and Services

In one embodiment, the user comprises a fleet manager, a sub-contracting vendor, a service provider, a customer, a business entity, an individual, or a third party. In one embodiment, the services include a subscription service, a prescription service, a marketing service, an advertising service, a notification service, a requested service, an ordered service, a scheduled delivery service, or any combination thereof. For example, the scheduled delivery services may include special repeat deliveries such as groceries, prescriptions, drinks, mail, documents, or any combination thereof.

In one embodiment, the services alternatively or further comprise a return of a good (e.g., a signed document), receiving one set of goods and returning a different set of goods (e.g., product replacement/returns, groceries, merchandise, books, recording, videos, movies, payment transactions, etc.), or a third-party user providing instruction and or authorization to a goods or service provider to prepare, transport, deliver and/or retrieve goods to a principal user in a different location. In one embodiment, the services further or alternatively comprise: advertising services, land survey services, patrol services, monitoring services, traffic survey services, signage and signal survey services, architectural building, or road infrastructure survey services.

In one embodiment, the service further or alternatively comprises processing or manufacturing a good. In one embodiment, the autonomous vehicle is configured to process or manufacture the good in-transit. In one embodiment, the processed or manufactured good comprises: a beverage with or without condiments (such as coffee, tea, carbonated drinks, etc.), a fast food, a microwavable food, a repeatable food, or a rehydratable food. In one embodiment, the service comprises a financial transaction. In one embodiment, the service comprises advertising, marketing, public safety, public service, or any combination thereof.

In one embodiment, the food or beverage items have an optimum temperature. For example, some food and beverage items (e.g., soups, rice dishes, burgers, tea, or coffee) may be preferentially received by a consumer when they are warm. Other food and beverage items (e.g., ice cream, sodas) are preferentially received by a consumer when they are cool. In some cases when items that are preferentially delivered hot and cold are delivered in the same autonomous or semi-autonomous vehicle, these items may be delivered in separate compartments with different temperature control systems managing the temperatures accordingly. In one embodiment, the food or beverage items have different sizes, shapes, and weights. Hence, in some cases, to maximize the efficiency of an autonomous or semi-autonomous vehicle which may have limited energy storage, size, or ability to carry items over a certain weighted threshold, it may be important for storage units of these autonomous and semi-autonomous vehicles (and the modular units therein) to have different shapes and sizes to effective store and deliver these differing items. In one embodiment, items of similar target temperature profiles are grouped together in the same storage unit or modular insert. In one embodiment, items of similar target size profiles may be grouped together in the same storage unit or modular insert. In one embodiment, items of different target weight profiles (e.g., one heavy item, one small item) may be grouped together in the same storage unit or modular insert.

### Digital Processing Device

In one embodiment, the platforms, systems, media, and methods described herein include a digital processing device, or use of the same. In further embodiments, the digital processing device includes one or more hardware central processing units (CPUs) or general-purpose graphics processing units (GPGPUs) that carry out the device's functions. In still further embodiments, the digital processing device further comprises an operating system configured to perform executable instructions. In one embodiment, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In one embodiment, suitable digital processing devices include, by way of non-limiting examples, server computers, desktop computers, laptop computers, notebook computers, sub-notebook computers, netbook computers, net pad computers, set-top computers, and media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In one embodiment, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®.

Those of skill in the art will recognize that suitable personal computer operating systems include, by way of non-limiting examples, Microsoft® Windows®, Apple® Mac OS X®, UNIX®, and UNIX-like operating systems such as GNU/Linux®. In one embodiment, the operating system is provided by cloud computing. Those of skill in the art will also recognize that suitable mobile smart phone operating systems include, by way of non-limiting examples, Nokia® Symbian® OS, Apple® iOS °, Research in Motion® BlackBerry OS®, Google® Android®, Microsoft® Windows Phone® OS, Microsoft® Windows Mobile® OS, Linux®, and Palm® WebOS®.

Those of skill in the art will also recognize that suitable media streaming device operating systems include, by way of non-limiting examples, Apple TV®, Roku®, Boxee®, Google TV®, Google Chromecast, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In one embodiment, the device includes a storage and/or memory device. The storage and/or memory device is one or more physical apparatuses used to store data or programs on a temporary or permanent basis. In one embodiment, the device is volatile memory and requires power to maintain stored information. In one embodiment, the device is non-volatile memory and retains stored information when the digital processing device is not powered. In further embodiments, the non-volatile memory comprises flash memory. In one embodiment, the non-volatile memory comprises dynamic random-access memory (DRAM). In one embodiment, the non-volatile memory comprises ferroelectric random-access memory (FRAM). In one embodiment, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing-based storage. In further embodiments, the storage and/or memory device is a combination of devices such as those disclosed herein.

In one embodiment, the digital processing device includes a display to send visual information to a user. In one embodiment, the display is a liquid crystal display (LCD). In further embodiments, the display is a thin film transistor liquid crystal display (TFT-LCD). In one embodiment, the display is an organic light emitting diode (OLED) display. In various further embodiments, on OLED display is a passive-matrix OLED (PMOLED) or active-matrix OLED (AMOLED) display. In one embodiment, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In one embodiment, the digital processing device includes an input device to receive information from a user. In one embodiment, the input device is a keyboard. In one embodiment, the input device is a pointing device including, by way of non-limiting examples, a mouse, trackball, track pad, joystick, game controller, or stylus. In one embodiment, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

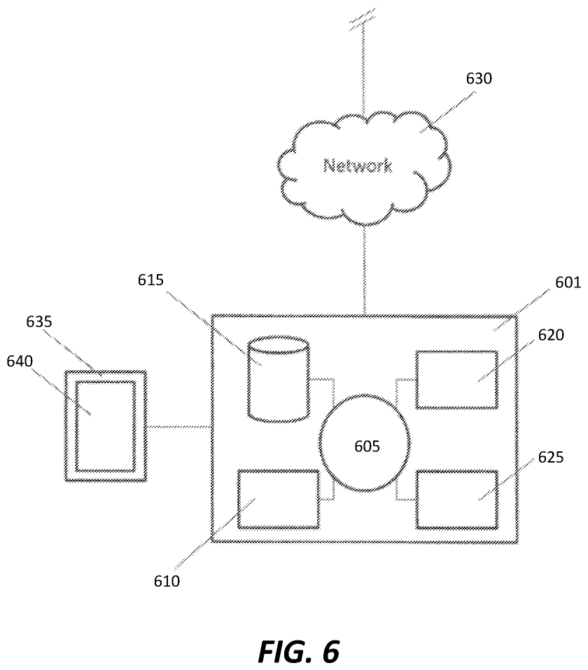

Referring to FIG. 6, in a particular embodiment, a digital processing device 601 is programmed or otherwise configured to managing autonomous vehicles. The device 601 is programmed or otherwise configured to manage autonomous vehicles. In this embodiment, the digital processing device 601 includes a central processing unit (CPU, also “processor” and “computer processor” herein) 605, which is optionally a single core, a multi core processor, or a plurality of processors for parallel processing. The digital processing device 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 comprises a data storage unit (or data repository) for storing data. The digital processing device 601 is optionally operatively coupled to a computer network (“network”) 630 with the aid of the communication interface 620. The network 630, in various cases, is the internet, an internet, and/or extranet, or an intranet and/or extranet that is in communication with the internet. The network 630, in some cases, is a telecommunication and/or data network. The network 630 optionally includes one or more computer servers, which enable distributed computing, such as cloud computing. The network 630, in some cases, with the aid of the device 601, implements a peer-to-peer network, which enables devices coupled to the device 601 to behave as a client or a server.

In one embodiment, the CPU 605 is configured to execute a sequence of machine-readable instructions, embodied in a program, application, and/or software. The instructions are optionally stored in a memory location, such as the memory 610. The instructions are directed to the CPU 105, which subsequently program or otherwise configure the CPU 605 to implement methods of the present disclosure. Examples of operations performed by the CPU 605 include fetch, decode, execute, and write back. The CPU 605 is, in some cases, part of a circuit, such as an integrated circuit. One or more other components of the device 601 are optionally included in the circuit. In some cases, the circuit is an application specific integrated circuit (ASIC) or a field programmable gate array (FPGA).

In one embodiment, the storage unit 615 optionally stores files, such as drivers, libraries and saved programs. The storage unit 615 optionally stores user data, e.g., user preferences and user programs. The digital processing device 601, in some cases, includes one or more additional data storage units that are external, such as located on a remote server that is in communication through an intranet or the internet.

In one embodiment, the digital processing device 601 optionally communicates with one or more remote computer systems through the network 630. For instance, the device 601 optionally communicates with a remote computer system of a user. Examples of remote computer systems include personal computers (e.g., portable PC), slate or tablet PCs (e.g., Apple® iPad, Samsung® Galaxy Tab, etc.), smartphones (e.g., Apple® iPhone, Android-enabled device, Blackberry®, etc.), or personal digital assistants.

### Non-Transitory Computer Readable Storage Medium

In one embodiment, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device.

### Computer Program

In one embodiment, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

### Web Application

In one embodiment, a computer program includes a web application. In one embodiment, a web application utilizes one or more database systems including, by way of non-limiting examples, relational, non-relational, object oriented, associative, and XML database systems

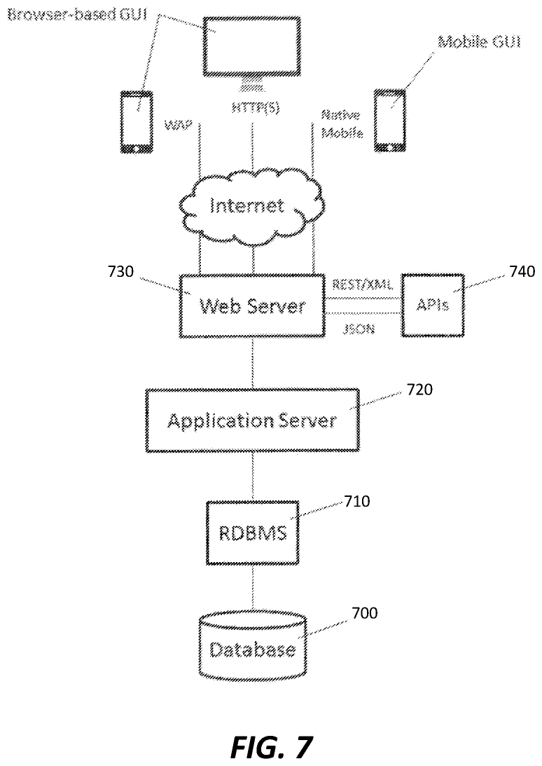

Referring to FIG. 7, in a particular embodiment, an application provision system alternatively has a distributed, cloud-based architecture 700 and comprises elastically load balanced, auto-scaling web server resources 710, and application server resources 1620 as well synchronously replicated databases 730.

Platform for Autonomously or Semi-Autonomously Delivering a Food or Beverage Item

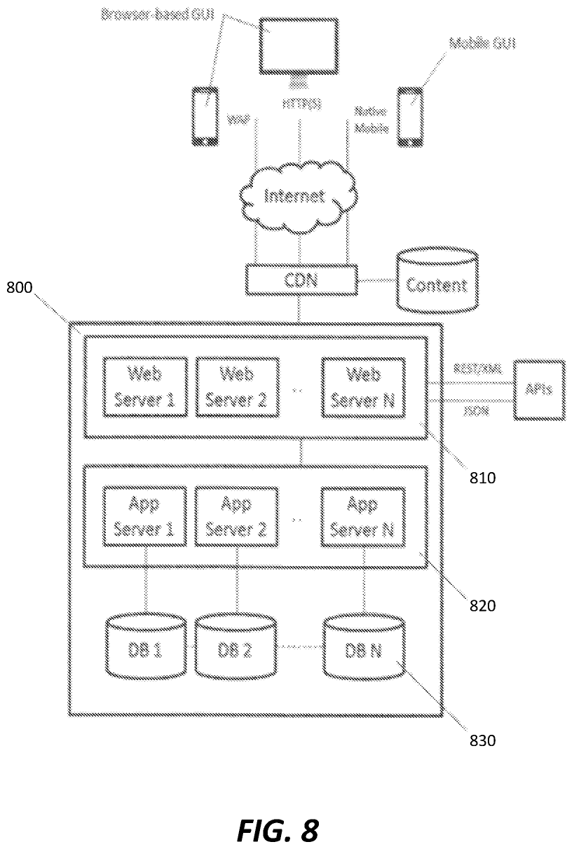

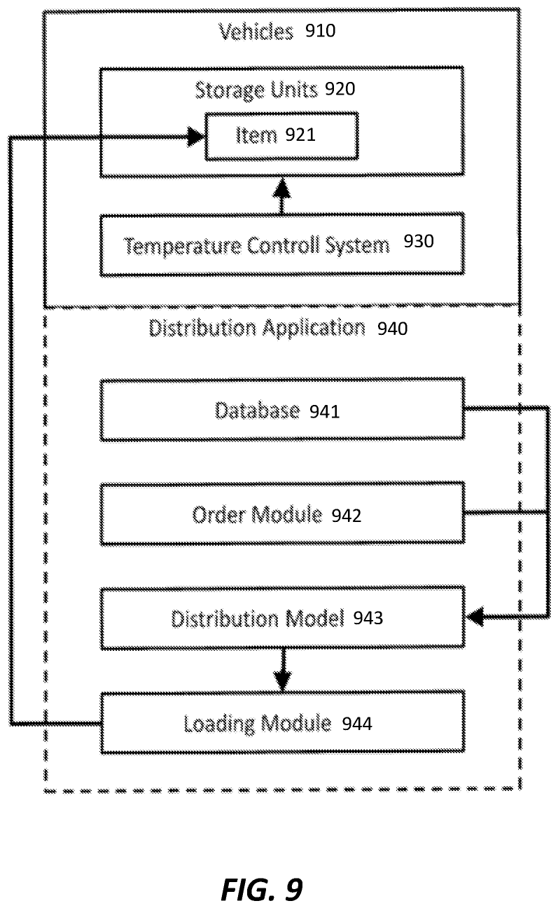

FIGS. 8 and 9, illustrate embodiments that are platforms for autonomously or semi-autonomously delivering a food or beverage item to a plurality of customers,

As illustrated in FIGS. 8(a) and 8(b), the platform for autonomously or semi-autonomously delivering a food or beverage item to a plurality of customers includes a plurality of autonomous or semi-autonomous vehicles 810, and a distribution processor configured to provide an item distribution application 840. Each vehicle 810 includes two or more storage units 820 and a temperature control system 830. In one embodiment, one or more vehicle includes one storage unit.

Each storage unit 820 may be configured to contain the food or beverage item. One or more of the storage units 820 includes a modular insert. The modular insert may be configured to secure the food or beverage item. In one embodiment, the modular insert comprises two or more modular insert types. Each modular insert type may be configured to secure a specific food or beverage item. In one embodiment, each of the storage units 820 comprise a sensor configured to sense a presence of the food or beverage item, the vending of the food or beverage item, or both.

In one embodiment the temperature control system 830 may be configured to maintain a target unit temperature within each of the two or more storage units 820. In one embodiment, each storage units 820 comprises a thermometer, and wherein the temperature control module directing the temperature control system 830 to maintain the target unit temperature based on a measurement of the thermometer. In one embodiment, each of the plurality of vehicles 810, each of the two or more storage units 820, or both further comprise a temperature control input configured to receive a manual temperature, and wherein the temperature control module directing the temperature control system 830 to maintain the target unit temperature based on the manual temperature. In one embodiment, the temperature control system 830 is configured to maintain a first target unit temperature within a first storage unit 820 and a second target unit temperature within a second storage unit.

In one embodiment, a distribution application 840 is provided with a database 841, an order module 842, a distribution module 843, and a loading module. The database 841 may store a plurality of item profiles and storage unit 820 profiles. Each item profile may be associated one of the food or beverage items, and a target item temperature. Each storage unit 820 profile may be associated with one of the two or more storage units 820 and one of the plurality of vehicles 810.

In one embodiment, the order module 842 may receive a plurality of orders from the plurality of customers. Each order includes one or more of the plurality items profiles

In one embodiment, the distribution module 843 assigns each of the one or more item profiles associated with each of the plurality of orders to one storage unit 820 profile. The distribution module 843 may assign each of the one or more item profiles associated with each of the plurality of orders to one storage unit 820 profile based at least on the target item temperature associated with each of the one or more item profiles associated with each of the plurality of orders. In one embodiment, each item profile is further associated with a size, and wherein the distribution module 843 further assigns each of the one or more item profiles associated with each of the plurality of orders to the storage unit 820 profile based on the size. In one embodiment, each storage unit 820 profile is further associated with a unit location within one of the pluralities of autonomous or semi-autonomous vehicles 810, and wherein the distribution module 843 further assigns each of the one or more item profiles associated with each of the plurality of orders to the storage unit 820 profile based on the unit location.

In one embodiment, the loading module may direct the loading of each of the one or more food or beverage items to at least one of the two or more storage units 820. The loading module may direct the loading of each of the one or more food or beverage items to at least one of the two or more storage units 820, based on the assignment of each of the one or more item profiles.

In one embodiment, at least a portion of the distribution processor includes a vehicle 810 distribution processor aboard the vehicle. In one embodiment, the distribution module 843 assigns each of the one or more item profiles associated with each of the plurality of orders to one storage unit 820 profile based on a machine learning algorithm, a rule-based algorithm, or both.

As a non-limiting example, in FIG. 9, the platform for autonomously or semi-autonomously delivering a food or beverage item to a plurality of customers includes a plurality of autonomous or semi-autonomous vehicles 910, and a distribution processor configured to provide an item distribution application 940. Each vehicle 910 includes two or more storage units 920 and a temperature control system 930.

As a non-limiting example, each storage unit 920 may be configured to contain the food or beverage item. One or more of the storage units 920 includes a modular insert. The modular insert may be configured to secure the food or beverage item. In one embodiment, the modular insert comprises two or more modular insert types. Each modular insert type may be configured to secure a specific food or beverage item. In one embodiment, each of the storage units 920 comprise a sensor configured to sense a presence of the food or beverage item, the vending of the food or beverage item, or both.

As a non-limiting example, T\the temperature control system 930 may be configured to maintain a target unit temperature within each of the two or more storage units 920. In one embodiment, each storage units 920 can include a thermometer, and wherein the temperature control module directing the temperature control system 930 to maintain the target unit temperature based on a measurement of the thermometer. In one embodiment, each of the plurality of vehicles 910, each of the two or more storage units 920, or both further comprise a temperature control input configured to receive a manual temperature, and wherein the temperature control module directing the temperature control system 930 to maintain the target unit temperature based on the manual temperature. In one embodiment, the temperature control system 930 is configured to maintain a first target unit temperature within a first storage unit 920 and a second target unit temperature within a second storage unit.

As a non-limiting example, the distribution application 940 includes a database 941, an order module 942, a distribution module 943, and a loading module. The database 941 may store a plurality of item profiles and storage unit 920 profiles. Each item profile may be associated one of the food or beverage items, and a target item temperature. Each storage unit 920 profile may be associated with one of the two or more storage units 920 and one of the plurality of vehicles 910.

The order module 942 may receive a plurality of orders from the plurality of customers. Each order includes one or more of the plurality item profiles.

The distribution module 943 may assign each of the one or more item profiles associated with each of the plurality of orders to one storage unit 920 profile. The distribution module 943 may assign each of the one or more item profiles associated with each of the plurality of orders to one storage unit 920 profile based at least on the target item temperature associated with each of the one or more item profiles associated with each of the plurality of orders. In one embodiment, each item profile is further associated with a size, and wherein the distribution module 943 further assigns each of the one or more item profiles associated with each of the plurality of orders to the storage unit 920 profile based on the size. In one embodiment, each storage unit 920 profile is further associated with a unit location within one of the pluralities of autonomous or semi-autonomous vehicles 910, and wherein the distribution module 943 further assigns each of the one or more item profiles associated with each of the plurality of orders to the storage unit 920 profile based on the unit location.

The loading module may direct the loading of each of the one or more food or beverage items to at least one of the two or more storage units 920. The loading module may direct the loading of each of the one or more food or beverage items to at least one of the two or more storage units 920, based on the assignment of each of the one or more item profiles.

In one embodiment, at least a portion of the distribution processor comprises a vehicle 910 distribution processor aboard the vehicle. In one embodiment, the distribution module 943 assigns each of the one or more item profiles associated with each of the plurality of orders to one storage unit 920 profile based on a machine learning algorithm, a rule-based algorithm, or both.

In one embodiment, the platform further comprises a server processor configured to provide a server application 950 comprising a remote temperature control module 951, receiving the target temperature, and transmitting the target temperature to the temperature control system 930. In one embodiment, at least a portion of the distribution processor comprises a server distribution processor.

### Storage Units

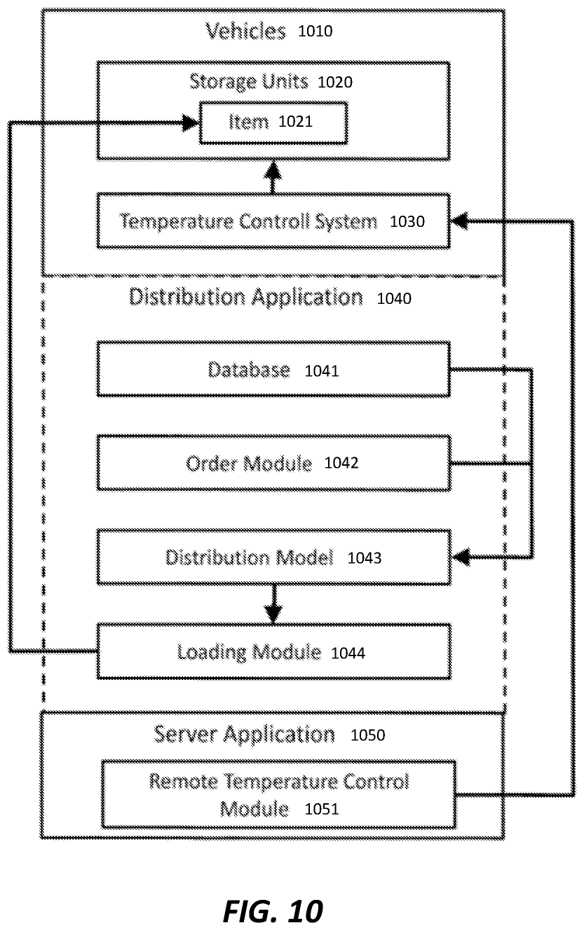

FIG. 10 is a non-limiting perspective illustration of storage units 1010 within a vehicle 101.

Each vehicle includes two or more storage units 1010. Each vehicle 101 includes only one storage unit. Each vehicle includes 2, 3, 4, 5, 6, 8, 10, 4, 2, 20, 25, 30, 40, 50, 60, 80, 100, or more storage units 1010, including increments therein. Each storage unit 1010 may be configured to contain the food or beverage item 1020. Each storage unit 1010 may be configured to contain two or more food or beverage items 1020. Each storage unit 1010 may be configured to contain 2, 3, 4, 5, 6, 8, 10, 4, 2, 20, 25, 30, 40, 50, 60, 80, 100, or more food or beverage items 1020, including increments therein.

As a non-limiting example, one or more of the storage units 1010 includes a modular insert. A majority of the storage units 1010 includes a modular insert. Each of the storage units 1010 includes a modular insert. Each storage unit 1010 includes 2, 3, 4, 5, 6, 8, 10, 4, 2, 20, 25, 30, 40, 50, 60, 80, 100, or more modular inserts, including increments therein. The modular insert may be configured to secure the food or beverage item 1020. The modular insert may be configured to secure one or more food or beverage items 1020. Two or more inserts may be required to store one food or beverage item 1020. In one embodiment, the modular insert comprises two or more modular insert types. Each modular insert type may be configured to secure a specific food or beverage item 1020.

In one embodiment, each of the storage units 1010 comprise a sensor configured to sense a presence of the food or beverage item 1020, the vending of the food or beverage item 1020, or both. Each of the storage units 1010 includes two or more sensors configured to sense a presence of the food or beverage item 1020, the vending of the food or beverage item 1020, or both. Each of the storage units 1010 comprise a sensor configured to sense an absence of the food or beverage item 1020, the vending of the food or beverage item 1020, or both. Each of the storage units 1010 comprise a sensor configured to detect the item 1020 profile associated with the food or beverage item 1020, the vending of the food or beverage item 1020, or both. The sensor includes a weight sensor, a touch sensor, a pressure sensor, an infrared sensor, a camera, a video camera, or any combination thereof.

### Temperature Control System

In one embodiment, the temperature control system may be configured to maintain a target unit temperature within each of the two or more storage units. The temperature control system may be configured to maintain a target unit temperature within only one of the storage units. The temperature control system may be configured to maintain the same target unit temperature within each of the two or more storage units. In one embodiment, each storage units comprises a thermometer, and wherein the temperature control module directing the temperature control system to maintain the target unit temperature based on a measurement of the thermometer.

In one embodiment, each of the plurality of vehicles, each of the two or more storage units, or both further comprise a temperature control input configured to receive a manual temperature. The temperature control module may direct the temperature control system to maintain the target unit temperature based on the manual temperature. In one embodiment, the temperature control system is configured to maintain a first target unit temperature within a first storage unit and a second target unit temperature within a second storage unit. The temperature control input includes a knob, a keypad, a wireless device, a Bluetooth device, a cellular device, a data port, or any combination thereof.

### Distribution Application

In one embodiment, the distribution application includes a database, an order module, a distribution module, and a loading module. In one embodiment, the distribution application is provided by the distribution processor. In one embodiment, the distribution application is provided by two or more distribution processors. In one embodiment at least one of the database, an order module, a distribution module, and a loading module are provided by the distribution processor. In one embodiment at least one of the database, an order module, a distribution module, and a loading module are provided by a vehicle processor. The vehicle processor may reside aboard the vehicle. In one embodiment at least one of the distribution processors and the vehicle processor comprises a cloud processor, a distributed processor, or any combination thereof.

### Database

The database may store a plurality of item profiles and storage unit profiles. Each item profile may be associated one of the food or beverage items. Each item profile may be associated one of the food or beverage items, and a target item temperature. Each storage unit profile may be associated with one of the two or more storage units and one of the plurality of vehicles. Each storage unit profile may be further associated with a target temperature capability. The database may be configured to be updated or appended by an administrator.

In one embodiment, the platforms, systems, media, and methods disclosed herein include one or more databases, or use of the same. In view of the disclosure provided herein, those of skill in the art will recognize that many databases are suitable for autonomous vehicles. In various embodiments, suitable databases include, by way of non-limiting examples, relational databases, non-relational databases, object-oriented databases, object databases, entity-relationship model databases, associative databases, and XML databases. Further non-limiting examples include SQL, PostgreSQL, MySQL, Oracle, DB2, and Sybase. In one embodiment, a database is internet-based. In further embodiments, a database is web-based. In still further embodiments, a database is cloud computing-based. In other embodiments, a database is based on one or more local computer storage devices.

### Order Module

The order module may receive a plurality of orders from the plurality of customers. Each order includes one or more of the plurality item profiles. Each order may further comprise a delivery address, a delivery time, a delivery state, or any combination thereof. The delivery state may be associated with the target item temperature, wherein, for example, a hot food may be associated with a delivery state configured for immediate consumption, or for subsequent reheating.

### Distribution Module

In one embodiment, the distribution module may assign each of the one or more item profiles associated with each of the plurality of orders to one storage unit profile. The distribution module may assign each of the one or more item profiles associated with an order to the same storage unit profile. The distribution module may assign each of the one or more item profiles associated with an order to different storage unit profile. The distribution module may assign item profiles associated with different orders to the same storage unit profile.

In one embodiment, the distribution module may assign each of the one or more item profiles associated with each of the plurality of orders to one storage unit profile based at least on the target item temperature associated with each of the one or more item profiles associated with each of the plurality of orders.

In one embodiment, each item profile is further associated with a size. The distribution module may further assign each of the one or more item profiles associated with each of the plurality of orders to the storage unit profile based on the size. In one embodiment, each storage unit profile is further associated with a unit location within one of the plurality of autonomous or semi-autonomous vehicles. The distribution module may further assign each of the one or more item profiles associated with each of the plurality of orders to the storage unit profile based on the unit location.

In one embodiment, the distribution module assigns each of the one or more item profiles associated with each of the plurality of orders to one storage unit profile based on the target temperature capability.

In one embodiment, the distribution module assigns each of the one or more item profiles associated with each of the plurality of orders to one storage unit profile based on a machine learning algorithm, a rule-based algorithm, or both.

### Loading Module

The loading module may direct the loading of each of the one or more food or beverage items to at least one of the two or more storage units. The loading module may direct the loading of each of the one or more food or beverage items to at least one of the two or more storage units, based on the assignment of each of the one or more item profiles. The loading of each of the one or more food or beverage items may be performed manually or autonomously.

The loading module may direct the loading of each of the one or more food or beverage items by providing a loading manifest. The loading module may direct the loading of each of the one or more food or beverage items by providing an instruction to each of the storage units to display an icon, barcode, part number, part name, or any combination thereof, associated with the food or beverage item. The loading module may direct the loading of each of the one or more food or beverage items by providing an instruction to a marquee, a speaker, a loading application, or any combination thereof.

### Server Processor

In one embodiment, the platform further comprises a server processor configured to provide a server application comprising a remote temperature control module, receiving the target temperature and transmitting the target temperature to the temperature control system. In one embodiment, at least a portion of the distribution processor comprises a server distribution processor.

### Mobile Application

In one embodiment, a computer program includes a mobile application provided to a mobile digital processing device. In one embodiment, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

### Standalone Application

In one embodiment, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In one embodiment, a computer program includes one or more executable complied applications.

### Web Browser Plug-In

In one embodiment, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In one embodiment, the web browser is a mobile web browser. Mobile web browsers (also called micro browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In one embodiment, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In one embodiment, software modules are in one computer program or application. In other embodiments, software modules are in more than one computer program or application. In one embodiment, software modules are hosted on one machine. In other embodiments, software modules are hosted on more than one machine. In further embodiments, software modules are hosted on cloud computing platforms. In one embodiment, software modules are hosted on one or more machines in one location. In other embodiments, software modules are hosted on one or more machines in more than one location.

In accordance with the description herein, suitable digital processing devices include, by way of non-limiting examples, server computers, desktop computers, laptop computers, notebook computers, sub-notebook computers, netbook computers, net pad computers, set-top computers, handheld computers, Internet appliances, mobile smartphones, tablet computers, personal digital assistants, video game consoles, and vehicles. Those of skill in the art will recognize that many smartphones are suitable for use in the system described herein. Suitable tablet computers include those with booklet, slate, and convertible configurations, known to those of skill in the art.

In one embodiment, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In one embodiment, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In one embodiment, the device includes a storage and/or memory device. The storage and/or memory device is one or more physical apparatus used to store data or programs on a temporary or permanent basis. In one embodiment, the device is volatile memory and requires power to maintain stored information. In one embodiment, the device is non-volatile memory and retains stored information when the digital processing device is not powered. In one embodiment, the non-volatile memory comprises flash memory. In one embodiment, the non-volatile memory comprises dynamic random-access memory (DRAM). In one embodiment, the non-volatile memory comprises ferroelectric random-access memory (FRAM). In one embodiment, the non-volatile memory comprises phase-change random access memory (PRAM). In one embodiment, the device is a storage device including, by way of non-limiting examples, CD-ROMs, DVDs, flash memory devices, magnetic disk drives, magnetic tapes drives, optical disk drives, and cloud computing-based storage. In one embodiment, the storage and/or memory device is a combination of devices such as those disclosed herein.

In one embodiment, the digital processing device includes a display to send visual information to a user. In one embodiment, the display is a cathode ray tube (CRT). In one embodiment, the display is a liquid crystal display (LCD). In one embodiment, the display is a thin film transistor liquid crystal display (TFT-LCD). In one embodiment, the display is an organic light emitting diode (OLED) display. In various some embodiments, on OLED display is a passive-matrix OLED (PMOLED) or active-matrix OLED (AMOLED) display. In one embodiment, the display is a plasma display. In one embodiment, the display is a video projector. In one embodiment, the display is interactive (e.g., having a touch screen or a sensor such as a camera, a 3D sensor, a LiDAR, a radar, etc.) that may detect user interactions/gestures/responses and the like. In still some embodiments, the display is a combination of devices such as those disclosed herein.

### Example 1—Order Distribution

In one example provided herein, the platform receives an order from a customer for a pizza and a pint of ice cream. The order module receives the item profiles associated with the pizza and the item profile associated with the ice cream.

In the database, the item profiles for the pizza are associated with a target item temperature of 100° F. and the ice cream is associated with a target item temperature of 0° F.

The distribution module then assigns the item profile associated with the pizza to storage unit 1 aboard vehicle 1, and assigns the item profile associated with the ice cream to storage unit 10 aboard vehicle 1.

The loading module then directs the loading of the pizza to storage unit 1 aboard vehicle 1, and the loading of the ice cream to storage unit 10 aboard vehicle 1.

### Example 2—Set Temperature Distribution

In one example provided herein, the platform receives an order from a customer for a pizza and a pint of ice cream. The order module receives the item profiles associated with the pizza and the item profile associated with the ice cream.

In the database, the item profiles for the pizza are associated with a target item temperature of 100° F. and the ice cream is associated with a target item temperature of 0° F.

As an item profile associated with a microwave dinner, which is associated with a target item temperature of 100° F. has been assigned to storage unit 1 aboard vehicle 1, the distribution module then assigns the item profile associated with the pizza to storage unit 1 aboard vehicle 1. The distribution module further assigns the item profile associated with the ice cream to storage unit 10 aboard vehicle 1.

The loading module then directs the loading of the pizza to storage unit 1 aboard vehicle 1, and the loading of the ice cream to storage unit 10 aboard vehicle 1.

### Example 3—Destination Distribution

In one example provided herein, the platform receives an order from customer B for a pizza and a pint of ice cream to location BB. The order module receives the item profiles associated with the pizza and the item profile associated with the ice cream.

In the database, the item profiles for the pizza are associated with a target item temperature of 100° F. and the ice cream is associated with a target item temperature of 0° F.

An item profile associated with a microwave dinner associated with a target item temperature of 100° F. has already been assigned to storage unit 1 aboard vehicle 1 which is associated with an order from customer A and location AA. As location AA is close to location BB, the distribution module then assigns the item profiles associated with the pizza and the ice cream to vehicle 1. The distribution module then assigns the item profiles associated with the item to storage unit 1 aboard vehicle 1, and assigns the item profile associated with the ice cream to storage unit aboard vehicle 1.

In the database, the item profiles for the pepperoni pizza are associated with a target item temperature of 100° F. and the ice cream is associated with a target item temperature of 0° F.

As a non-limiting example, as an item profile associated with a microwave dinner, which is associated with a target item temperature of 100° F. has been assigned to storage unit 1 aboard vehicle 1, the distribution module then assigns the item profile associated with the pepperoni pizza to storage unit 1 aboard vehicle 1. As both the pizza and the ice cream are ordered for delivery to the same location, and to ensure that the ice cream does not absorb the pepperoni aromas, the distribution module then assigns the item profile associated with the ice cream to storage unit 10 aboard vehicle 1, wherein storage unit 10 is located far from storage unit 1.

The loading module then directs the loading of the pizza to storage unit 1 aboard vehicle 1, and the loading of the ice cream to storage unit 10 aboard vehicle 1.

It is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

1. An electric vehicle in a fleet, comprising:
a first electric vehicle including one or more components that have unique identifications and having a unique public key stored at the one or more components, the electric vehicle being coupled to a cloud that includes a server;
wherein when a message is received by the first electric vehicle, the first and second components provide a verification of their existence, the first and second components decrypting and verifying their parts of the message; and
a first electric vehicle processor, the first electric vehicle processor configured to provide at least one of a database, an order module, a distribution module, and a loading module.

2. The electric vehicle of claim 1, further comprising:
a plurality of storage compartments including a first storage compartment and a second storage compartment.

3. The electric vehicle of claim 1, wherein the database is arranged to store a plurality of storage compartment profiles associated with the plurality of storage compartments.

4. The electric vehicle of claim 1, wherein the plurality of storage compartment profiles include a first storage compartment profile associated with the first storage compartment and a second storage compartment profile associated with the second storage compartment.

5. The electric vehicle of claim 1, wherein the database stores at least one item profile associated with the at least one item and a target item temperature for the item.

6. The electric vehicle of claim 1, wherein the distribution module is arranged to assign the at least one item profile associated with the order to at least one of the plurality of storage compartments using the plurality of storage compartment profiles based at least on the target item temperature and the location of the at least one of the plurality of storage compartments.

7. The electric vehicle of claim 1, wherein the loading module is arranged to direct loading of the at least one item into the at least one of the plurality of storage compartments based on an assignment of the at least one item profile.

8. The electric vehicle of claim 1, further comprising:
a conveyance system arranged to translate the vehicle autonomously or semi-autonomously;
a plurality of storage compartments including a first storage compartment and a second storage compartment.

9. The electric vehicle of claim 1, further comprising
a vehicle processor, the vehicle processor configured to provide at least one of a database, an order module, a distribution module, and a loading module, wherein
a) a database is arranged to store a plurality of storage compartment profiles associated with the plurality of storage compartments, the plurality of storage compartment profiles including a first storage compartment profile associated with the first storage compartment and a second storage compartment profile associated with the second storage compartment, the database further being arranged to store at least one item profile associated with the at least one item and a target item temperature for the item, wherein the first storage compartment profile includes a location of the first storage compartment on the vehicle and the second storage compartment profile includes a location of the second storage compartment on the vehicle;
an order module is arranged to obtain an order from a customer, wherein the order includes the at least one item profile,
a distribution module is arranged to assign the at least one item profile associated with the order to at least one of the plurality of storage compartments using the plurality of storage compartment profiles based at least on the target item temperature and the location of the at least one of the plurality of storage compartments, and
a loading module is arranged to direct loading of the at least one item into the at least one of the plurality of storage compartments based on an assignment of the at least one item profile.

10. The electric vehicle of claim 1, wherein the order is a first order and wherein the first order includes a first delivery state, the first delivery state being associated with the target item temperature.

11. The electric vehicle of claim 2 wherein the at last one item profile includes a first item profile and a second item profile, the distribution module being arranged to assign the first item profile to the first storage compartment profile and the second item profile to a second storage compartment profile based on the location of the second storage compartment being far from the first storage compartment.

12. The electric vehicle of claim 1 wherein the at least one item profile associated with a size, and wherein the distribution module further assigns the at least one item profile at least one of the first storage compartment profile and the second storage compartment unit profile based on the size.

13. The electric vehicle of claim 1 wherein the electric vehicle processor is configured to provide the at least one of a database, the order module, the distribution module, and the loading module.

14. The electric vehicle of claim 1 further including:
a temperature control system, the temperature control system configured to maintain a first storage compartment target temperature within at least the first storage compartment.

15. The electric vehicle of claim 6 wherein the temperature control system is further configured to maintain a second storage compartment target temperature within the second storage compartment.

16. The electric vehicle of claim 1 further including:
a display case, the display case arranged in the first storage compartment;
a temperature control system, the temperature control system configured to maintain a first storage compartment target temperature within the display case.

17. The electric vehicle of claim 1 wherein the electric vehicle processor is configured to provide the database and the electric vehicle further includes:
a communication module, wherein the electric vehicle communicates with a fleet management system using the communication module to exchange information with the order module, the distribution module, and the loading module.

18. The electric vehicle of claim 1 wherein the first storage compartment is securable and the second storage compartment is securable, and wherein the first storage compartment and the second storage compartment are separately securable.

19. The electric vehicle of claim 1, further comprising:
a conveyance system arranged to translate the electric vehicle autonomously or semi-autonomously.

20. The electric vehicle of claim 1, further comprising:
a temperature control system, the temperature control system configured to maintain a first storage compartment target temperature within the first storage compartment, the temperature control system further configured to maintain a second storage compartment target temperature within the second storage compartment.
